(19) United States
(12) Patent Application Publication
(10) Pub. No.: US 2013/0206484 A1
(43) Pub. Date: Aug. 15, 2013

(54) SYSTEM AND METHOD FOR WEIGHING ARTICLES

(71) Applicants: Salvatore Fabrizio Consoli, Bologna (IT); Roberto Trebbi, Castenaso (IT)

(72) Inventors: Salvatore Fabrizio Consoli, Bologna (IT); Roberto Trebbi, Castenaso (IT)

(73) Assignee: I.M.A. INDUSTRIA MACCHINE AUTOMATICHE S.P.A., Ozzano dell'Emilia (IT)

(21) Appl. No.: 13/809,776

(22) PCT Filed: Aug. 19, 2011
(86) PCT No.: PCT/IB2011/053657

§ 371 Date: Mar. 20, 2013

(30) Foreign Application Priority Data
Aug. 20, 2010 (IT) BO2010A000522

(51) Int. Cl. G01G 13/02

(52) U.S. Cl. CPC G01G 13/026
USPC 177/1; 177/119

(57) ABSTRACT

A total weight checking system and method for capsules filled with product includes a filling machine for filling the capsules according to a defined filling order, a weighing apparatus for weighing all the capsules and a transferring arrangement transferring for the capsules from the filling machine to the weighing apparatus. The transferring arrangement includes a removing arrangement and a conveying arrangement, the removing arrangement being suitable for removing the capsules from the filling machine and for transferring the capsules to the conveying arrangement according to the defined filling order, the conveying arrangement being suitable for housing and accumulating a plurality of capsules according to the defined filling order and transferring the capsules to the weighing apparatus according to the defined filling order.

The present invention relates to a system and a method for weighing articles, in particular capsules, gelcaps or similar elements, filled with pharmaceutical products by an automatic filling machine.

In processes of filling hard gelatine capsules with liquid, powder, granular or compressed pharmaceutical products, using weighing apparatuses or devices placed downstream of the filling machine, or of the filling group, is known to measure the weight of the product dosed inside the capsules. It is necessary to check the weight to reject from production non-conforming capsules—for example because they contain a quantity of product outside the permitted dosage tolerance range—and/or to correct possible excesses or defects in dosing of the product.

Especially in the pharmaceutical field, it is very important to check that the weight of the product dosed in the single capsules is exactly the required dose, with very narrow tolerance ranges.

Generally, the capsules are weighed once only at the end of dosing, as the weight of the empty capsules is known and contained within a preset tolerance range, indicated and guaranteed by the suppliers/manufacturers of the capsules. In this manner, from the measurement of the weight of the filled capsules (gross weight) by subtracting the known weight of the empty capsules (tare), it is possible to calculate the weight of the dosed product (net weight) with a certain degree of precision.

The weighing apparatuses that perform this type of direct measurement comprise electronic scales, which are typically provided with load cells on which the capsules have to be positioned for a suitable time.

Systems and weighing apparatuses are also known that perform this type of measurement indirectly, for example by means of capacitive sensors that are suitable for detecting the weight of the product dosed inside the capsules by exploiting the chemical and physical features of the product. Such indirect weighing systems and apparatuses are generally less accurate and precise than direct weighing by scales and load cells.

Weight checking can be partial, statistical, i.e. conducted on a sample of filled capsules chosen at random, or can be total, conducted on all the filled capsules leaving the filling machine (total or 100% weight check).

In the filling processes in which the quantity of product to be dosed inside each capsule is very small, for example just a few milligrams (so-called “microdosages”) and/or the range of tolerance required for the product dosage is close, for example ±10%, it is clear that normal variations in the weight of the empty capsules affect and greatly influence the weight measurement. In fact, as the weight of the empty capsules is comparable to that of the dosed product, such weight variations can be greater than the tolerance range on the required dosage. In this case, checking only the weight of the filled capsules is not sufficient to ensure that the quantity of dosed product is within the required limits and it is necessary to weigh each empty capsules beforehand and calculate the weight of the dosed product through the difference.

For this purpose, weighing systems have been devised that comprise a first weighing unit, upstream of the machine or of the filling unit, which measures the weight of the empty capsules (tare), and a second weighing unit, downstream of the filling machine, which measures the weight of the filled capsules (gross weight). The filled capsules leaving the filling machine are sent to an accumulating tank from which they are then sent, one at a time, to the second weighing unit. The difference between the gross weight and the tare, measured and stored for each capsule by a control unit of the machine, enables said control unit to calculate the net weight of the dosed product.

As the capsules are accumulated in a random manner in the tank and are transferred from the latter to the second weighing unit, again in a random manner, it is not, however, possible to associate the gross weight of a filled capsule with the tare of the corresponding empty capsule, so that the detected net weight is of necessity imprecise.

An object of the present invention is to improve total or 100% weight checking systems and methods for weighing all articles such as capsules or similar elements filled with a product by a filling machine or packaged by a packaging machine.

Another object is to provide a system for measuring by a weighing apparatus the weight of all the capsules leaving the filling machine, which enables the speed of the filling machine and/or of the weighing apparatus to be varied, in particular which enables the filling machine to be kept operative during weighing apparatus downtime.

A further object is to devise a total or 100% weight checking system and method that enable the position of each capsule to be identified with precision and in real time, ensuring the traceability of the capsule, to control through feedback filling systems of the filling machine.

A further object is to devise a total weight checking system and method that enable the position of each capsule to be identified with precision and in real time, ensuring the traceability of the capsule, to identify precisely and accurately single dosators that are malfunctioning and thus to be replaced.

Such objects and still others are reached by a system and a method devised according to one or more of the claims set out below.

The invention can be better understood and implemented with reference to the attached drawings that illustrate some embodiments thereof by way of non-limiting example, in which:

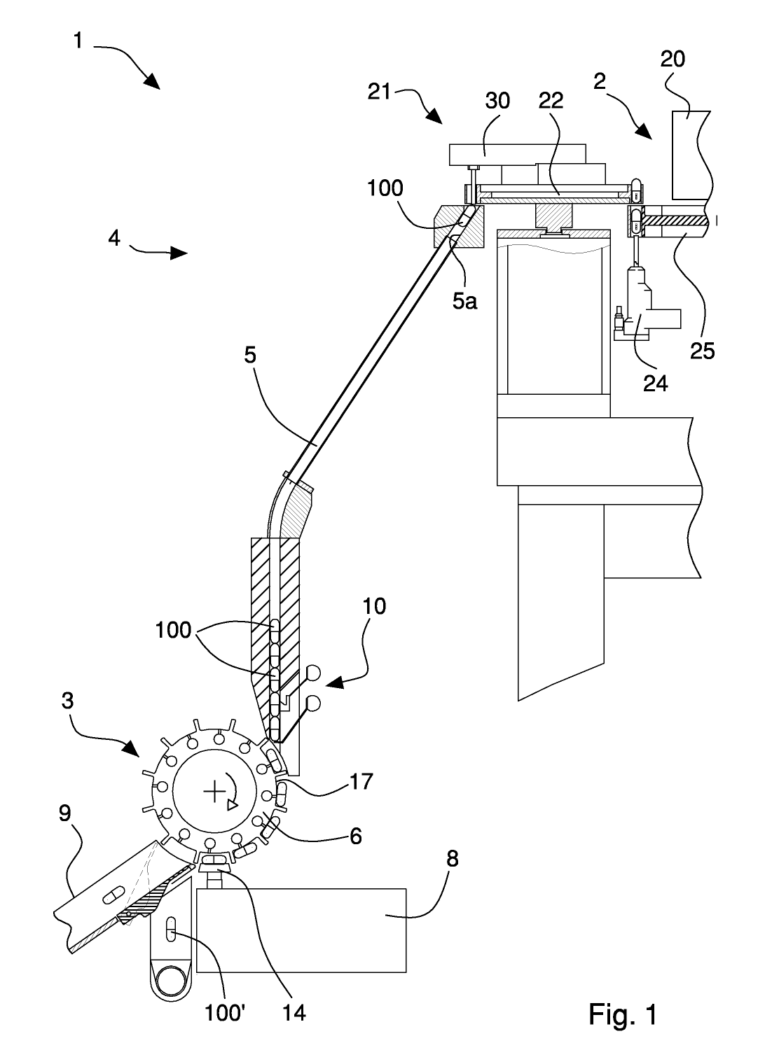

FIG. 1 is a schematic front, partially section view of a total weight checking system for weighing capsules, or similar elements, according to the invention in association with a filling machine for filling such capsules, which is partially illustrated;

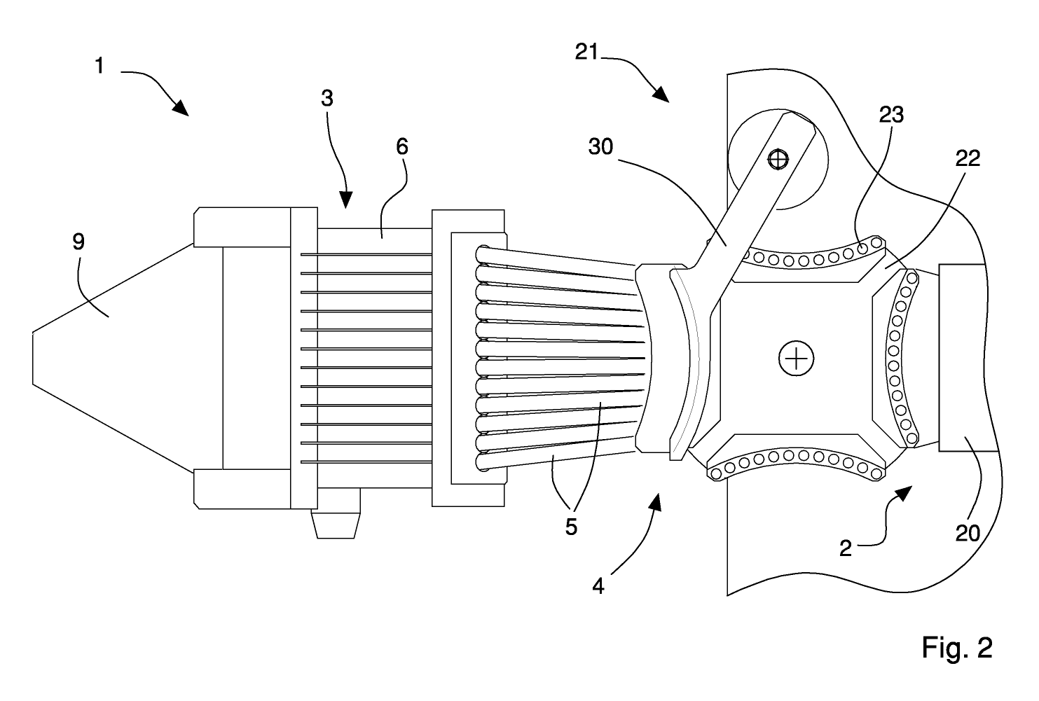

FIG. 2 is a schematic plan view of the system in FIG. 1;

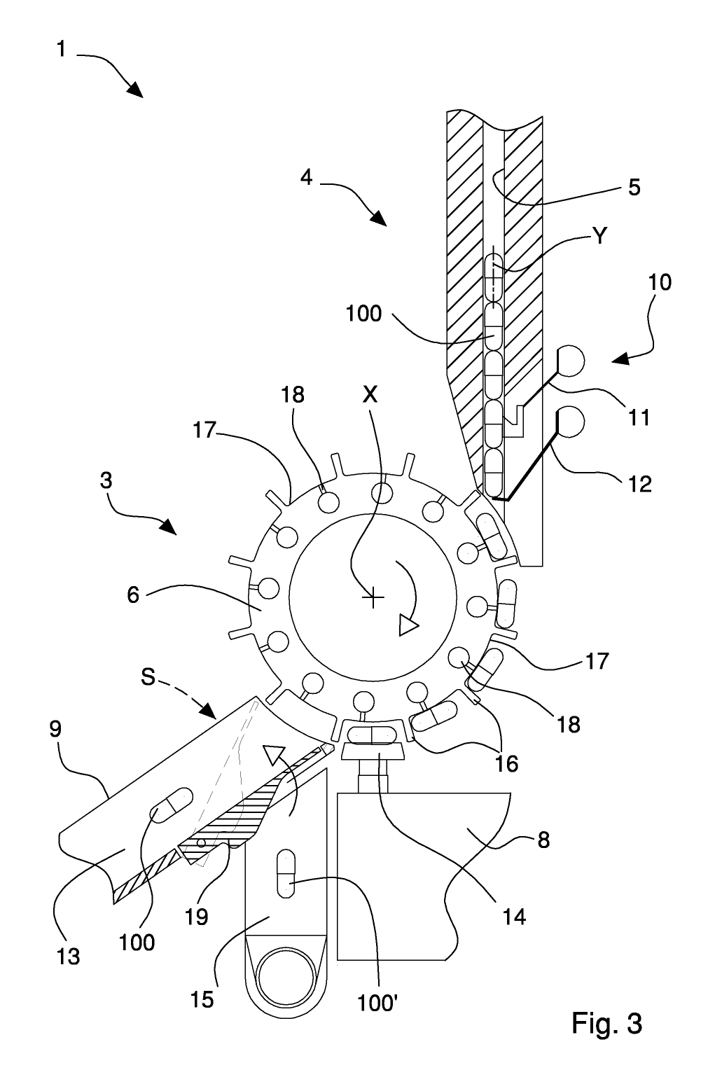

FIG. 3 is an enlarged detail of FIG. 1, illustrating a weighing apparatus for weighing the capsules and, partially, transferring means for transferring said capsules;

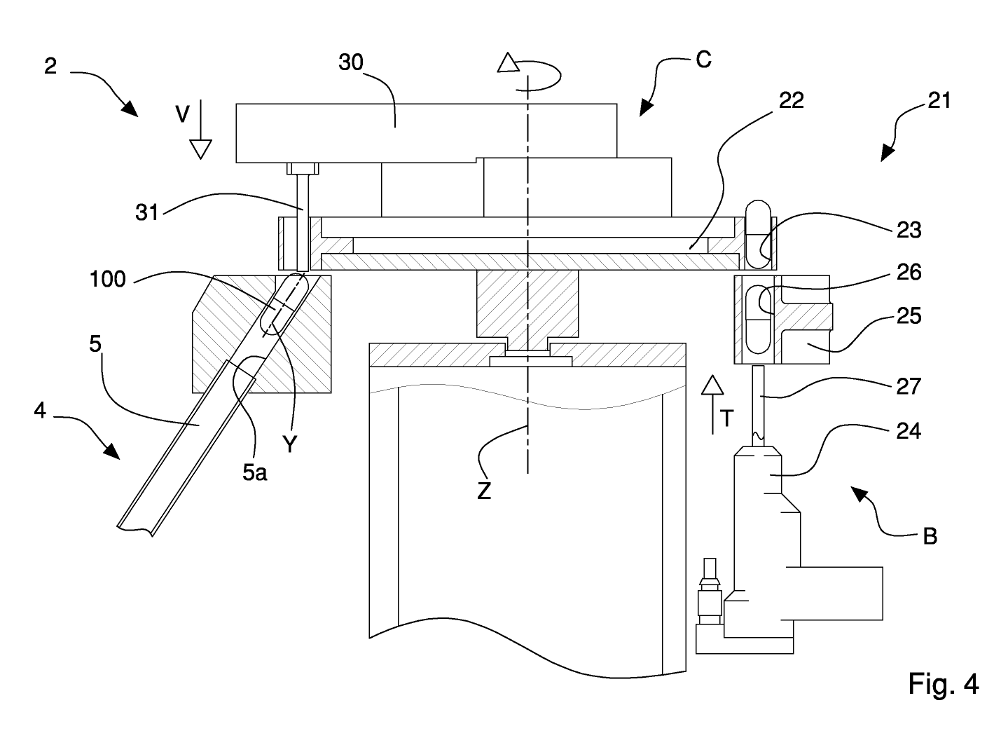

FIG. 4 is another enlarged detail of FIG. 1, illustrating the transferring means in association with a movement wheel of the filling machine.

With reference to FIGS. 1 to 4, there is illustrated a total or 100% weight checking system 1 for weighing articles 100, in particular capsules, or similar elements, filled with product according to a defined filling order in a packaging machine 2, in particular a filling machine 2, of known type and not illustrated in detail, with one or more filling stations or groups 20. The capsules 100 are, for example, of the lid-bottom type and are made of hard gelatine.

The system 1 comprises a weighing apparatus 3 to measure the weight of the capsules 100 and transferring means 4 to transfer the latter from the filling machine 2 to the weighing apparatus 3 according to the filling order.

The transferring means 4 comprises removing means 21 for removing the filled capsules 100 from the filling machine 2 and conveying means 5 for receiving the aforesaid capsules 100 from the removing means 21 and conveying the aforesaid capsules 100 in sequence and according to the filling order as far as the weighing apparatus 3.

The conveying means comprises one or more conduits 5 arranged for housing through accumulation a plurality of capsules 100 coming from the filling machine 2 during operation, typically in the event of arrest and/or slowing of the aforesaid weighing apparatus 3.

The conduits 5 are arranged for receiving the capsules 100 released by the removing means 21 and conveying the capsules 100 slidably by gravity to movement means 6 of the weighing apparatus 3.

In one embodiment that is not shown, pressure means can be provided that is connected above to the conduits 5 (or vacuum means can be provided that is connected below to the conduits 5) to encourage the descent of the capsules 100.

The conduits 5 are substantially parallel to one another, each of which comprising a first portion, adjacent to the filling machine 2 and tilted, and a second portion, adjacent to the weighing apparatus 3 and substantially vertical.

Each conduit 5 has an internal (for example circular) section with a shape and dimensions that are such as to enable sliding by gravity of the capsules 100 arranged with the respective longitudinal axis Y parallel to the aforesaid conduit 5 (FIGS. 3 and 4). The length of the conduit 5 is such as to be able to receive a plurality of capsules 100—in particular a defined maximum number of capsules—arranged aligned and stacked, in mutual contact, in the event of an arrest or slowing of the weighing apparatus 3. As explained in greater detail further on in the description, the conveying means 5 acts as a storage unit or accumulating magazine for the capsules 100.

The transferring means 4 comprises arresting means 10 that is selectively drivable for releasing the capsules 100 to the movement means 6, in an operative condition of the system 1 in which the weighing apparatus 3 is regularly operative, or for locking the capsules 100 accumulating in the conduits 5, for example in an arrest condition of the weighing apparatus 3.

The arresting means 10, of known type and illustrated schematically in the figures, comprises, for example for each conduit 5 a respective pair of arresting levers 11, 12 driven in combination to enable one capsule 100 at a time to descend in the movement means 6 when the system 1 is in the operative condition.

The movement means 6 transfers each capsule 100 singularly from the respective conduit 5 of the transferring means 4 to a weighing unit 8 and from the latter to outlet means 9.

With particular reference to FIG. 3, the movement means 6 includes drum means that rotates around an axis X, for example a horizontal axis, and is provided with a plurality of peripheral housings 17 that are suitable for receiving respective capsules 100 from the conduits 5. The drum means is further provided with retaining means 18 that is suitable for locking the capsules 100 in and releasing the capsules 100 from the respective housings 17.

The retaining means 18 is, for example, of the air suction or vacuum type and comprises sucking holes made at the housings 17 and connected by internal conduits to a sucking or vacuum source that is of known type and is not illustrated.

The weighing unit 8 comprises electronic scales provided with one or more load cells 14, arranged parallel, that are able to measure in a weighing time the weight of one capsule 100 at a time. In particular, the number of load cells 14 is the same as the number of conduits 5.

The outlet means 9 comprises a plurality of slide conduits provided with respective deviating means 19 that is movable and drivable in a reject position S such as to direct possible capsules 100′ with a non-conformant weight to the collecting means 15.

With particular reference to FIG. 4, the removing means 21 of the transferring means 4 positions the filled capsules 100 at respective conduits 5 and comprises a transferring wheel 22 that is rotatable in an indexed manner or intermittently around a vertical axis Z and is provided with a plurality of first peripheral seats 23 that is able to receive and retain the capsules 100 coming from a filling station or group 20 of the filling machine 2 located upstream. In particular, the transferring wheel 22 transfers the capsules 100 from a movement wheel 25 of the filling machine 2 to the conveying means 5 in a guided and orderly manner according to the defined filling order.

The removing means 21 includes inserting means 24 that extracts the capsules 100 from second seats 26 of the movement wheel 25 and inserts said capsules 100 in the first seats 23 of the transferring wheel 22.

The first seats 23 of the transferring wheel 22 and the second seats 26 of the movement wheel 25 comprise respective through and converging cavities, for example cavities with a conical shape that enable the capsules 100 to be inserted on one side and along a preset insertion direction and prevent the exit thereof from the opposite side. Owing to the converging shape, the capsules 100 can be locked inside the seats 23, 26 through interference.

With reference to the embodiment illustrated in the figures, the second seats 26 of the movement wheel 25 converge downwards, also to prevent the capsules 100 falling during the transfer, whilst the first seats 23 of the transferring wheel 22 converge upwards to enable the transfer from the movement wheel 25 to the transferring wheel 22.

The inserting means 24 comprises a plurality of pins 27 that are drivable singly and independently of one another between a lowered non-operative position B, in which they do not interfere with the movement wheel 25, and a raised operative position (which is not illustrated) in which they are inserted inside the second seats 26 of the movement wheel 25 so as to extract the capsules 100 from the movement wheel 25 and push the capsules 100 in the first seats 23 of the transferring wheel 22. The pins 27 are movable from the lowered non-operative position B to the raised operative position according to an inserting direction T of the capsules 100 in the first seats 23 of the transferring wheel 22 that is directed from the bottom to the top.

The transferring wheel 22 is suitable for positioning the first seats 23, and thus the capsules 100 contained therein, at, and immediately above, inlets 5a of the respective conduits 5 of the transferring means 4.

The inlets 5a of the conduits 5 are thus arranged immediately below the first seats 23.

The transferring means 21 further comprises extracting means to transfer in a guided manner and according to the defined filling order the capsules 100 from the first seats 23 of the transferring wheel 22 to the respective conduits 5 through the inlets 5a.

The extracting means 30 includes a plurality of further pins that are movable between a respective raised position (not illustrated), in which they do not interfere with the transferring wheel 22, and a respective lowered position C in which they are inserted inside the first seats 23 of the transferring wheel 22 so as to extract the capsules 100 from the transferring wheel 22 and push the capsules 100 into the conduits 5. The further pins 31 are movable according to an extracting direction V of the capsules 100 from the first seats 23 of the transferring wheel 22 that is opposite the inserting direction T, i.e. directed from top to bottom.

In one version of the system that is not illustrated, the extracting means 30 comprises nozzles for blowing a jet of pressurised air into the first seats 23 of the transferring wheel 22 to push out the capsules 100 downwards.

During normal operation of the system 1 of the invention, the capsules 100 are removed by the transferring means 4 from the movement wheel 25 of the filling machine 2, in particular the capsules 100 are inserted into the conduits 5 by the extracting means 30, which extracts the aforesaid capsules 100 from the transferring wheel 22, the latter receiving the capsules 100 extracted from the movement wheel 25 by the inserting means 24.

The capsules 100 descend by gravity inside the respective conduits 5 until they come to stop at the arresting means 10, which releases one capsule 100 at a time to the drum means 6.

The latter rotate with reciprocal movement with angular steps to transfer the capsules 100 from the conduits 5 to the load cells 14 of the scales 8. During the transfer to the load cells 14, the capsules 100 remain locked in the respective housings 17 owing to the retaining means 18 that is activated.

When a housing 17 is at the respective load cell 14, during rotation of the drum means 6, the retaining means 18 acting on said housing is deactivated so as to enable the corresponding capsule 100 to be released onto the load cell 14, which measures the weight thereof.

The weighing time that is necessary for weighing a capsule 100 is less than the downtime of the drum means 6 between two successive angular steps in the reciprocating motion.

At the end of weighing, the drum means is rotated and by protruding elements 16 of the peripheral housings 17 the drum means pushes the capsule 100 that has just been weighed to a respective sliding conduit 13 of the outlet means 9.

If the weight of the capsule 100 is conformant, the deviating means 19 is maintained in a rest position, whilst if the weight of the capsule 100′ is not conformant, the deviating means 19 is arranged in a reject position S to deviate the aforesaid capsule to the collecting means 15.

It should be noted that during normal operation the operative speed of the weighing apparatus 3, i.e. the time corresponding to a step of the drum means 6, is substantially the same as the operative speed of the filling machine 2, i.e. the time corresponding to a step of the transferring wheel 22. In other words, the number of capsules over the unit of time leaving the filling machine 2 is substantially the same as the number of capsules weighed over the unit of time by the weighing apparatus 3.

It should be noted that the transferring means 4 acting as a storage unit or accumulating magazine of the capsules 100 enable the respective operative speeds of the filling machine 2 and of the weighing apparatus 3 to be separated.

For example, if the movement means 6 has to be arrested to enable cleaning and/or resetting operations to be performed on the load cells 14 of the scales 8, it is possible to maintain the filling machine 2 in operation without stopping the filling machine 2, at least for a preset period of time. The capsules 100, in fact, can be progressively housed in a row and accumulated, stacked on top of one another, inside the conduits 5 according to the filling order. The aforesaid filling order is assured by the removing means 21, which is able to remove one after the other in an ordered sequence the capsules 100 from the movement wheel 25 and then transfer the capsules 100 and insert the capsules 100 in the same sequence into the conveying means 5.

At the end of these cleaning and/or resetting operations, it is possible to increase the speed of the weighing apparatus and dispose of the accumulated capsules 100 until the weighing apparatus 3 is again placed in step with the filling machine 2, without losing the productivity of the filling machine 2.

It should be noted that this accumulating method ensures the traceability of each cap 100 because the capsules 100 are housed and accumulated according to the filling order, i.e. “in phase”, i.e. stacked in the order or sequence in which they have been filled in the filling machine 2 and thus transferred from the removing means 21 to the conduits 5. Further, the capsules 100 are transferred from the conduits 5 to the weighing apparatus 3, where they are always weighed in phase. In other words, the filling order of the capsules 100 is maintained by the filling station 20 of the filling machine 2 through the movement wheel 25, the transferring wheel 22, the conveying means 5 and the drum means 6 as far as the weighing unit 8.

Maintaining the capsules 100 in phase as far as the weighing apparatus 3 enables the position of each capsule 100 inside the filling machine 2 and the weighing system 1 to be identified each instant and data relating to the weight of all the capsules 100 to be obtained, which data can be effectively used to control the filling machine 2 through feedback, in particular the filling station 20, and to identify single defective and malfunctioning dosators. In fact, as only capsules filled by the same dosator reach the same load cell, irregular filling of single capsules 100 detected by the weighing unit 8 can be immediately associated with single dosators, which can thus be replaced. On the other hand, if the capsules 100 were to reach the weighing unit 8 in a random order (for example by feeder hoppers) and were to be weighed at random, data would be obtained that were time-disconnected from the filling machine 2 and not associated with the single dosators, so that feedback control actions of the dosing groups or stations of the filling machine 2 would of necessity be imprecise and ineffective, and it would be impossible to associate a single cap 100 with the corresponding dosator that had carried out the filling and it would be impossible to identify possible malfunctioning single dosators.

In the case of multidosages, performed in filling machines 2 with several filling stations, in order to identify malfunctions of single dosators of the filling stations, it is possible to operate the filling machine 2 preliminarily with just one filling station at a time, such as to associate the weight of each single capsule 100 with only one dosator.

In order to control through feedback the filling machine 2, control means is provided (which is not illustrated) comprising a processing unit connected to the weighing apparatus 3 that processes data relating to the weight of the capsules 100 accumulated in phase in the conduits 5 and weighed in the weighing apparatus 3. On the basis of such data, the control means controls the filling stations of the filling machine 2.

It is also possible, for example in the event of microdosages, to associate with the filling machine 2 a further weighing apparatus, for example an electronic scale with one or more load cells, for weighing the empty capsules 100 and further transferring means for transferring in an orderly manner to the filling machine 2 the empty capsules 100 weighed by the further weighing apparatus. The further transferring means can advantageously comprise one or more further carousels or movement wheels, for example of the type of the movement wheel 22 illustrated, with a plurality of peripheral housings suitable for receiving and transferring in an orderly manner the capsules 100. This further transferring means can also comprise one or more further conduits of the type illustrated before to house and accumulate in step the empty weighed capsules. These further conduits can advantageously connect the further weighing apparatus to the further movement wheel, or to the filling machine 2.

It is thus possible for each capsule 100 to detect in an accurate and precise manner the weight when empty (tare) and the weight when filled (gross weight) and to calculate through the weight difference the weight of the dosed product (net weight). In this manner, possible variations in the weight of the empty capsules cannot influence the final measurement.

For this purpose, the processing unit is connected to the weighing apparatus 3 and to the further weighing apparatus to receive data relating to the weights measured directly for each processed, empty and filled capsule 100.

It is opportune to note that the transferring means 4 of the invention also enables the speed of the filling machine 2 to be slowed without slowing or stopping the weighing apparatus 3.

It is possible to apply the total weight checking method of the invention to the weighing system 1 and to the filling machine 2 to weigh all the capsules 100, or similar elements, filled with product in the aforesaid filling machine.

This method comprises the steps of filling the empty capsules 100 by one or more filling groups or stations of the filling machine 2 according to a preset filling order; removing the filled capsules 100 from the filling machine and conveying the filled capsules 100 by the removing means 21, to the conveying means 5; accumulating the filled capsules 100 in the conveying means 5; transferring the filled capsules 100 from the conveying means 5 to the weighing apparatus 3; weighing the filled capsules 100 in the weighing apparatus 3 to detect data relating to the weight of the filled capsules 100; the filled capsules 100 being removed and conveyed, accumulated, transferred and weighed according to the aforesaid predefined filling order. Advantageously, the method can further process data relating to the weight of the filled capsules 100 in a processing unit; and controlling, on the basis of said data, the filling groups or stations of the filling machine 2 by control means.

It is further possible, as explained before, to identify and replace, on the basis of said data, possible malfunctioning single dosators of the aforesaid one or more filling groups or stations of the filling machine 2.

The advantages of the aforesaid method are the same as those of the weighing system specified above.

It should be noted how with the system and method according to the invention it is possible to check all the filled capsules 100, i.e. it is possible to achieve total or 100% weight checking without losing productivity.

Modifications can be made to the disclosed system and method that are all part of the invention.

For example, conduits with a different shape and dimensions from those of the conduits 5 illustrated in the figures can be made according to specific geometrical arrangements of the filling machine 2 and of the weighing apparatus 3.

1-15. (canceled)

16. A total weight checking system for capsules, or similar elements, filled with product comprising a filling machine suitable for filling the capsules according to a defined filling order, a weighing apparatus for weighing all the capsules and a transferring arrangement for transferring the capsules from said filling machine to said weighing apparatus, wherein said transferring arrangement comprises a removing arrangement and a conveying arrangement, said removing arrangement being suitable for removing the capsules from said filling machine and for transferring the capsules to said conveying arrangement according to said defined filling order, said conveying arrangement being positioned below said removing arrangement and being suitable for housing and accumulating, in particular in the event of stopping or slowing of said weighing apparatus, a plurality of capsules according to said defined filling order and transferring the capsules to the weighing apparatus according to said defined filling order.

17. A system according to claim 16, wherein said conveying arrangement comprises at least one conduit arranged for receiving respective capsules from said removing arrangement and conveying the capsules slidably to said weighing apparatus according to said defined filling order, said at least one conduit having a respective inlet arranged immediately below the removing arrangement for receiving from the latter the capsules in a guided manner and according to said defined filling order.

18. A system according to claim 17, wherein said at least one conduit has an internal section of a shape and dimensions such as to enable the capsules to slide to said weighing apparatus and length such as to house and accumulate a definite number of capsules arranged, aligned and stacked according to said defined filling order.

19. A system according to claim 18, wherein said transferring arrangement comprises an arresting arrangement that is selectively drivable for releasing the capsules to said weighing apparatus, in an operating condition, or for locking the capsules that accumulate inside said conveying arrangement, in particular in the event of a stoppage of said weighing apparatus.

20. A system according to claim 16, wherein said removing arrangement comprises:
a transferring wheel for transferring said capsules from a movement wheel of the filling machine to said conveying arrangement, said transferring wheel being provided with a plurality of first seats that are suitable for receiving and retaining the capsules received from the movement wheel;
an inserting device for extracting the capsules from second seats of said movement wheel and inserting the capsules in the first seats of said transferring wheel;
an extracting arrangement for extracting the capsules from the first seats of said transferring wheel and pushing the capsules into said conveying arrangement.

21. A system according to claim 20, wherein at least said first seats comprise respective through and converging cavities in such a manner as to enable the capsules to be inserted on one side and along a preset insertion direction and to prevent the exit thereof from an opposite side, further locking the capsules through interference.

22. A system according to claim 21, wherein said conveying arrangement comprises at least one conduit arranged for receiving respective capsules from said removing arrangement and conveying the capsules slidably to said weighing apparatus according to said defined filling order, said at least one conduit having a respective inlet arranged immediately below the removing arrangement for receiving from the latter the capsules in a guided manner and according to said defined filling order and wherein said inlet of at least one conduit is arranged immediately below respective said first seats, said extracting arrangement being movable along an extracting direction to push downwards the capsules in the respective conduits through the respective inlets.

23. A system according to claim 16, comprising a control device with a processing unit connected to the weighing apparatus suitable for processing data relating to weights of filled capsules accumulated in said transferring arrangement and weighed in the weighing apparatus according to said defined filling order, said control device being suitable for controlling filling groups or stations of the filling machine on the basis of said data.

24. A system according to claim 23, comprising a further weighing apparatus for weighing empty capsules and a further transferring arrangement for transferring in an orderly manner the empty capsules weighed by the further weighing apparatus to the filling machine.

25. A system according to claim 24, wherein the control device with the processing unit is connected to the further weighing apparatus to process data relating to weights of the empty capsules, said control device being suitable for obtaining net weights of the capsules on the basis of said weights of the empty and filled capsules.

26. A total weight checking method for capsules, or similar elements, comprising the steps of:
filling empty capsules by at least one filling station of a filling machine according to a defined filling order;
removing filled capsules from the filling machine and conveying the filled capsules by a removing arrangement of a transferring arrangement, to a conveying arrangement of the transferring arrangement;
accumulating the filled capsules in said conveying arrangement;
transferring the filled capsules from said conveying arrangement to a weighing apparatus; and
weighing the filled capsules in the weighing apparatus to detect data relating to weights of the filled capsules;
wherein the filled capsules are removed and conveyed, accumulated, transferred and weighed according to said defined filling order.

27. A method according to claim 26 and further comprising the steps of:
processing said data relating to the weight of the filled capsules in a processing unit; and
controlling, on the basis of said data, the at least one filling station of the filling machine by a control device.

28. A method according to claim 26, and further comprising the steps of:
processing said data relating to the weight of the filled capsules in a processing unit; and
identifying, on the basis of said data, possible single malfunctioning dosators of said at least one filling station of the filling machine.

29. A method according to claim 28, and comprising the step of replacing said possible single malfunctioning dosators.

30. A method according to claim 26, and comprising the steps of:
weighing empty capsules in a further weighing apparatus to detect data relating to weights of the empty capsules;
transferring in an orderly manner the empty capsules from the further weighing apparatus to the filling machine; and
obtaining net weights of the filled capsules on the basis of said data relating to weights of the empty and filled capsules.
